(19) United States
(12) Patent Application Publication
(10) Pub. No.: US 2010/0000512 A1
(43) Pub. Date: Jan. 7, 2010

(54) Pollutant Removing Device and Dual-Air Curtain Range Hood Using the Device

(76) Inventor: Rong Fung HUANG, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 12/168,543

(22) Filed: Jul. 7, 2008

(51) Int. Cl. F24C 15/20; B01D 50/00

(52) U.S. Cl. 126/299 D; 210/522

(57) ABSTRACT

A pollutant removing device includes first and second air blow devices respectively located at front and rear ends of a pollutant generation source or an oven and respectively including a first elongate air blow slot and a second elongate air blow slot so as to blow air upward. A suction device is located above a counter top to which the pollutant generation source or the oven is installed. The suction device includes at least one elongate suction opening which is connected with a suction machine. The at least one elongate suction opening is parallel to the first and the second elongate air blow slots. Two air curtains are formed between the at least one elongate suction opening and the first and second elongate air blow slots. The gas, vapor, or particulate type pollutants located between the two air curtains is sucked via the at least one elongate suction opening.

### FIELD OF THE INVENTION

The present invention relates to a device for removing gas, vapor, particulate, or mixed type pollutants, and more particularly, to a range hood generates two air curtains above the counter top so as to remove pollutants between the two air curtains.

### BACKGROUND OF THE INVENTION

Generally, kitchens, laboratories or dust factories generate gas with grease particles or toxic gases which are harmful to the people in the sites and pollutes the surroundings.

Taken the conventional kitchen hood as an example, as show in FIG. 12, the hood 10 is fixed to an underside of the cabinet 15 in which a pipe 12 is received. The pipe 12 guides the gas sucked by the hood from the cook ware and expel the gas out of the kitchen. The cabinet 15 is connected with other cabinet 16 on the wall 14 to which the hood 10 is connected and the other wall 13 that is perpendicular to the wall 14 is in contact with a side of the hood 10. The oven 18 is installed in the counter top 17 and includes two burners 19. The counter top 17 is connected on the top of yet another cabinet 20. The hood 10 includes two suction fans 11 which are located above the burners 19 so as to suck the gas from the cook ware into the hood 10 and the gas can be expelled out side of the kitchen via the pipe 12.

The conventional range hoods 10 used in kitchens are similar to a canopy hood which is used in working sites. As shown in FIG. 13, the upward speed of the gas flow decreases quickly with the increase of the downward distance beneath the suction face. At the distance further than about 1.5 times of the diameter of the suction opening, the upward velocity becomes negligibly small and the suction force would not be large enough to draw effectively the gas. Therefore, the effective suction distance beneath the canopy hood is generally within about 1.5 times of the diameter of the suction opening. Besides, because of the characteristics of the suction flow field of the canopy hood, the gas flow can easily be affected by drafts such as the air flows generated from fans, air conditioning device, people walking by, opening or closing doors or windows, etc. When such interference air flows exist, as shown in FIG. 14, the flow field beneath the canopy hood would be modified drastically and the capture zone will become an area like the half-oval enclosed in a dividing streamline. The larger the ratio of the interference air flow speed to the suction speed presents, the smaller the capture zone becomes. When this situation happens, the grease particles, toxic gases, or pollutants originally generated under the hood is extremely tentative to be dispersed to the environment and therefore are more easily attached to the wall and inhaled by the users. One of the most intuitive way of avoid happening of this situation is to install the canopy hood as low as possible towards the position of the pollutants. In practical applications, however, the hood cannot be installed too low because movements and operations of cook wares or apparatus by hands or tools in the room between the table top and the canopy hood are commonly required. Because that the draft currents generated by fans, air conditioning device, people walking by, opening or closing doors or windows almost exist around the hood all the time, the conventional hood therefore can hardly have satisfied performance.

FIG. 15 shows an improved rang hood wherein three cross-flow fans 21 are installed on the front side, left side, and right side of the oven to provide three upward-issuing slot jets. This design is aimed to use the three cross-flow fans 21 cooperated with the back wall to reduce the negative effects of the draft currents generated in the environment. However, because the area above the oven is enclosed by the three jets generated by the three fans 21 and the back wall, the pollutants around the lower portion of the enclosed area would present unsteady, chaotic flow motions with violent three-dimensional tumbling and swirling vortices. The reason why this arrangement would inevitably induce instability of flow is because of the unbalanced mass and momentum conservation laws. The induced turbulent dispersion would therefore reduce the efficiency of pollutant removal through the canopy hood installed at a distance above the oven. Because the residence time of the grease particles and pollutants staying around the area above the oven becomes much longer due to the vortical motion of the flow, it becomes very dangerous when the draft currents pass over—the high-concentration grease particles and pollutants accumulated in that area may be dispersed by the cross flow. Besides, the chaotic motions of the vortical flow structures induced by the three cross-flow fans may affect the flames of the burners, e.g., drift or extinguishment of flames, and reduce the burning efficiency.

As mentioned above, the conventional kitchen hoods cannot effectively remove the pollutants and this is because of the poor fluid dynamics of the air flow that the conventional kitchen hoods generate.

### SUMMARY OF THE INVENTION

The primary object of the present invention is to provide a gaseous, vapor, particulate, or mixed type pollutant removing device which includes two elongate air blow devices installed on the front and rear ends of the counter top and an elongate suction device located at a distance above the counter top and between the two air blow devices so as to form two air curtains such that the gaseous, vapor, or particulate type pollutants generated between the two air curtains can be effectively sucked by the elongate suction hood installed above the counter top. By this arrangement the compensation air is naturally provided into the capture zone from two “open sides” of the dual-air curtain so that the flow field would behave more like “two-dimensional” although in strict sense it is not. The three-dimensional, unsteady tumble and swirl vortical flows would not appear so that the pollutants generated between the two air curtains can be effectively sucked by the elongate suction device located at a distance above the counter top and the influences on the flames can be reduced.

In order to achieve the objects mentioned above, the present invention relates to a pollutant removing device which comprises first and second air blow devices which are respectively located at a front end and a rear end of a pollution source on a counter top as well as a suction device is located above the counter top and includes at least one elongate suction opening which is connected with a suction machine. The first and second air blow devices respectively may also be elongate air blow slots so as to blow air upward. The elongate suction opening(s) of the suction device located above the counter top is parallel to the first and second elongate air blow slots. The first and second elongate air blow slots issue upward two planar jets and drawn by the at least one elongate suction opening of the suction device to form two air curtains so that the pollutants between the air curtains would be less affected by the draft currents existing in the environment. The at least one elongate suction device draws the pollutants encapsulated between the two air curtains out to the outdoors through the suction opening(s).

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIGS. 1A-1C show the basic theory used in the pull-push air curtains of the present invention;

FIG. 2 is a side view to show the pollutant removing device of the present invention;

FIG. 3 is a front view of the pollutant removing device of the present invention;

FIG. 4 is a perspective view to show the dual-air curtain range hood of the present invention;

FIGS. 5 and 6 show the flow field results tested by laser Doppler velocimeter (LDV) while no top cabinet and back wall are existed;

FIGS. 7 and 8 show the flow field results tested by laser Doppler velocimeter (LDV) while the top cabinet and back wall are existed;

FIG. 9 shows the results of capture efficiencies by using a large upright board to simulate drafts generated by fan, air conditioner, or walk-by of people for both of the hood of the present invention and the conventional hood;

FIG. 10 shows the oil collection device used in the hood of the present invention;

FIG. 11 shows a cross sectional view of the connection of the oil collection device and the hood of the present invention;

FIG. 12 shows a conventional range hood;

FIG. 13 shows the non-dimensional upward velocity on central axis under hood opening when tested by laser Doppler velocimeter;

FIG. 14 shows the capture zone of a conventional hood subject to influence of cross draft when tested by laser Doppler velocimeter, and

FIG. 15 shows the conventional range hood with left, right and front upward-blowing jets.

### DETAILED DESCRIPTION OF THE PREFERRED EMBODIMENT

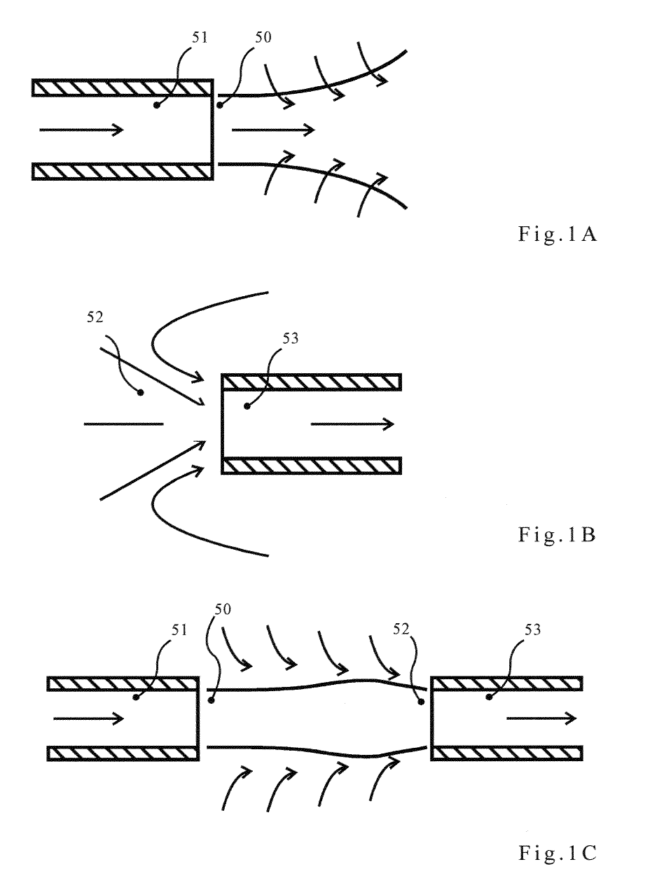

FIGS. 1A-1C show the hand sketches of the simplified flow fields associated to a planar jet, a suction slot, and a combination of the jet and the suction slot, respectively. As shown in FIG. 1A, a jet 50 is ejected from a nozzle 51 from the left to the right. During the evolution process the environmental air nearby the jet 50 would be entrained inward through the jet boundary. The jet 50 therefore will expand outward in the downstream area. The fashion of expansion will depend on the characteristic regimes of Reynolds number. Downstream the nozzle 51 within a distance about 80 nozzle diameters, the momentum conservation usually is observed. The jet may expand, break up and disperse quickly after a distance about 100˜150 nozzle diameters downstream the nozzle 51. During the evolution processes of the jet 50, continuous exchanges of momentum, mass, and heat happen between the jet 50 and the nearby environmental air. As shown in FIG. 1B, a suction slot 53 draws air from the left to the right. The air flows around the suction slot 53 are denoted by reference 52. The active suction area is located within a downstream distance from the suction slot 53 to about only 1.5 times diameters of the suction slot 53, as mentioned previously. Individual use of the jet usually lead to early dispersion and individual use of the suction slot usually lead to poor suction capability at the distance beyond the effective suction range. As shown in FIG. 1C, when a jet 50 and a suction slot 53 are arranged face to face at a distance, the flow field in-between the two physical devices varies with the suction strength provided by the suction slot 53 and the Reynolds number of the jet issued from the nozzle 51. If the factors mentioned above are properly adjusted, the poor suction capability of the individual suction slot beyond the effective suction range and the early dispersion characteristics of the individual jet can be improved by the interaction between the jet and the suction which is called the push-pull effect. As this happens, an air curtain which can resist the interference of side drafts to some levels can be established.

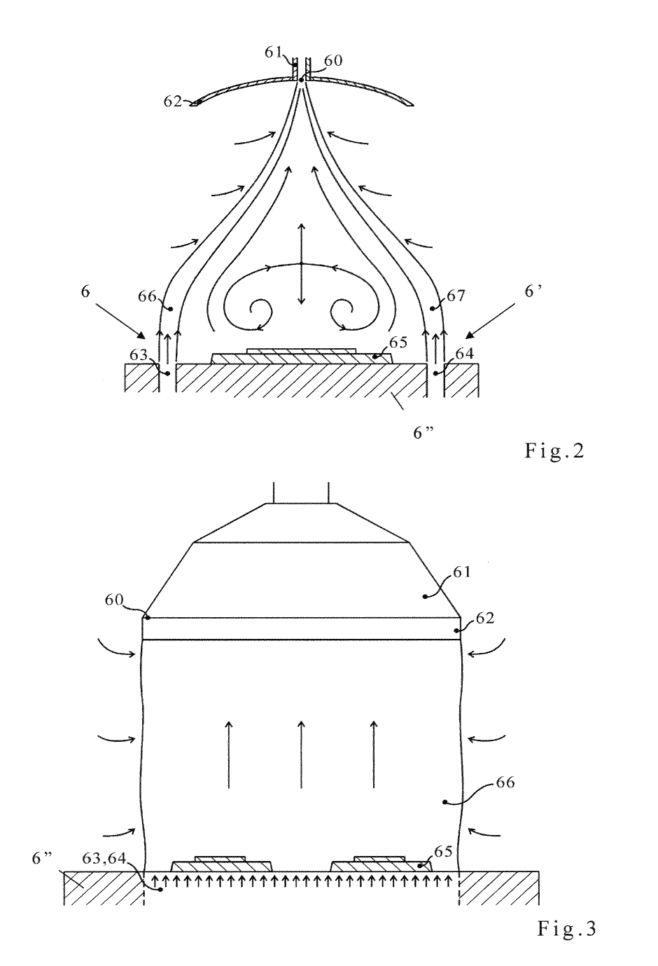

As shown in FIG. 2 and 3, a preferable embodiment of the pollutant removing device includes a first air blow device 6 and a second air blow device 6′ respectively located at a front end and a rear end of a pollutant generation source 65 which is installed in a counter top 6″. The first and second air blow devices 6, 6′ respectively include a first elongate air blow slot 63 and a second elongate air blow slot 64 so as to blow air upward. The first and second elongate air blow slots 63, 64 are respectively located in parallel to the front and rear ends of the pollutant generation source 65. A suction device 61 is located above the counter top 6″ to which the pollutant generation source 65 is installed and the suction device 61 includes at least one elongate suction opening 60 which is connected with a suction machine which is not shown. The at least one elongate suction opening 60 is arranged parallel to the first and second elongate air blow slots 63, 64. The number of the elongate suction opening 60 can be two. In a preferable embodiment, there is one elongate suction opening 60 which is located above the first and second elongate air blow slots 63, 64.

A rectangular suction device 61 is located at a distance from the counter top 6″ and two flanges 62 extend from two sides of the elongate suction opening 60 of the suction device 61. The upward-blowing jets issued from the first and second elongate air blow slots 63, 64 located at the front and rear end of the counter top 6″ associated with the upward-drawing suction flow induced by the elongate suction opening 60 form the two inclined air curtains 66, 67 as shown in FIGS. 2 and 3. Because of the existence of the counter top 6″, no air can be fed from the underside. A recirculation bubble therefore is formed above the counter top 6″ between the two air curtains 66, 67. The air flows inside and outside the recirculation bubble are exchanged by the turbulence diffusion. The air flows above the recirculation bubble are drawn by the suction device 61 and released to outside of the room. The two sides above the counter top 6″ are left open or equipped with grids or porous boards through which the compensation air can be naturally provided into the area between the two air curtains as shown in FIG. 3 so that the air flows are steady.

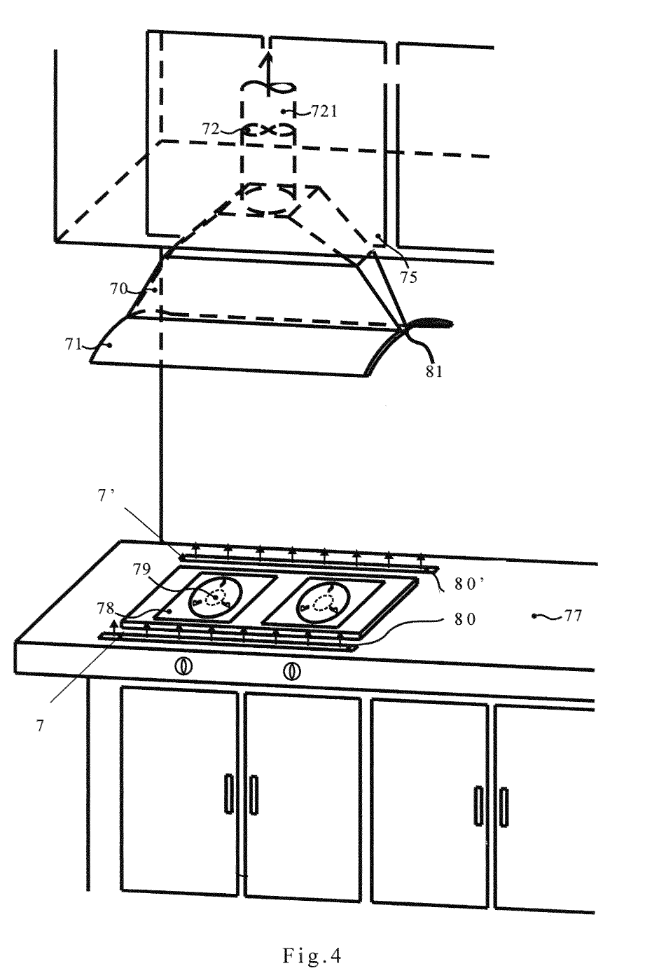

As shown in FIG. 4, a dual-air curtain range hood using the pollutant removing device is disclosed and comprises a first air blow device 7, a second air blow device 7′ and a suction device 70, wherein the first and second air blow devices 7, 7′ are respectively located at a front end and a rear end of an oven 79 installed on a counter top 77. The first and second air blow devices 7, 7′ respectively include a first elongate air blow slot 80 and a second elongate air blow slot 80′, the first and second elongate air blow slots 80, 80′ are located in parallel to the front and rear ends of the oven 79 and blow air upward. The suction device 70 is located above the counter top 77 to which the oven 79 is installed and includes at least one elongate suction opening 81 which is connected with a suction machine 72. The at least one elongate suction opening 81 is parallel to the first and second elongate air blow slots 80, 80′. The number of the elongate suction opening 81 can be two, preferably, one elongate suction opening 81 is located between the first and second elongate air blow slots 80, 80′.

The suction device 70 includes an elongate suction opening 81 which forms a suction opening facing downward and two flanges 71 extend from two sides of the elongate suction opening 81. The suction device 70 is located at a certain height from the counter top 78 so as to provide an upward suction force. The elongate suction opening 81 is connected with a suction machine 72 which is located in the cabinet 75 above the counter top 78 so as to reduce noise. The pipe 721 is opened to outside of the room or is connected to a filter/oil-separation device/oil-collection device and then brings the pollutant out of the room. Two flanges 71 extend from the two sides of the elongate suction opening 81 of the suction device 70. The first and second air blow devices 7, 7′ are located at the front and rear ends of the oven 79. The first air blow device 7 and the second air blow device 7′ are two cross flow fans which are co-operated with the suction machine 72. The first and second air blow devices 7 and 7′ can be two elongate slots and cooperated with a blower (not shown) so as to form two upward-blowing air jets.

The two upward-blowing air jets issued from the first and second air blow devices 7, 7′ installed at the front and rear ends of the oven 79 combined with the upward suction flow generated by the suction device 70 that has the elongate suction opening 81, a dual-air curtain flow structure which can prevent the pollutant from escaping from the capture area is formed. The air curtain at the rear end of the oven 79 can effectively prevent the grease particles from attaching on the wall on the rear end of the counter top 78. Besides, the two sides above the counter top 77 are opened so that air can be sucked into the area between the two air curtains to feed the suction action. By this way, the flow field can maintain nearly “two-dimensional.” The two sides above the counter top 77 may have porous boards or grids to allow the air be drawn into the area between the two air curtains with small flow resistance.

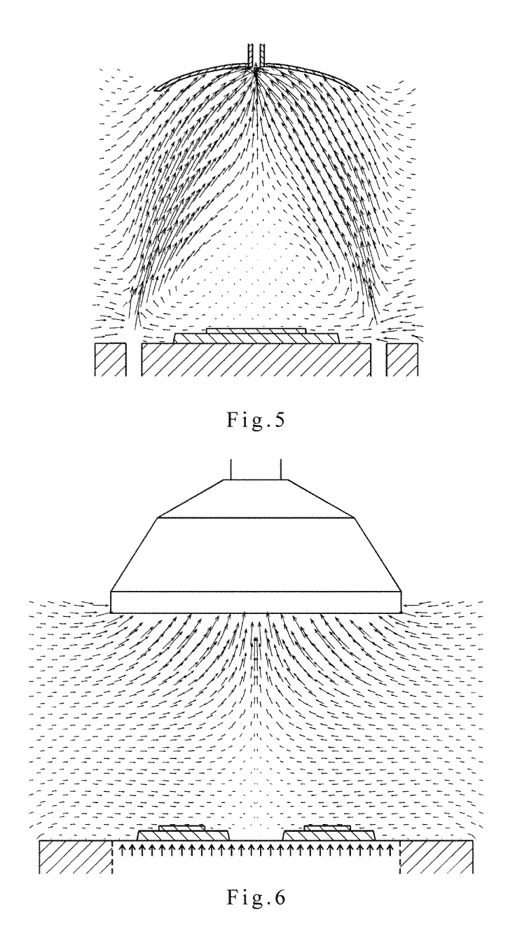

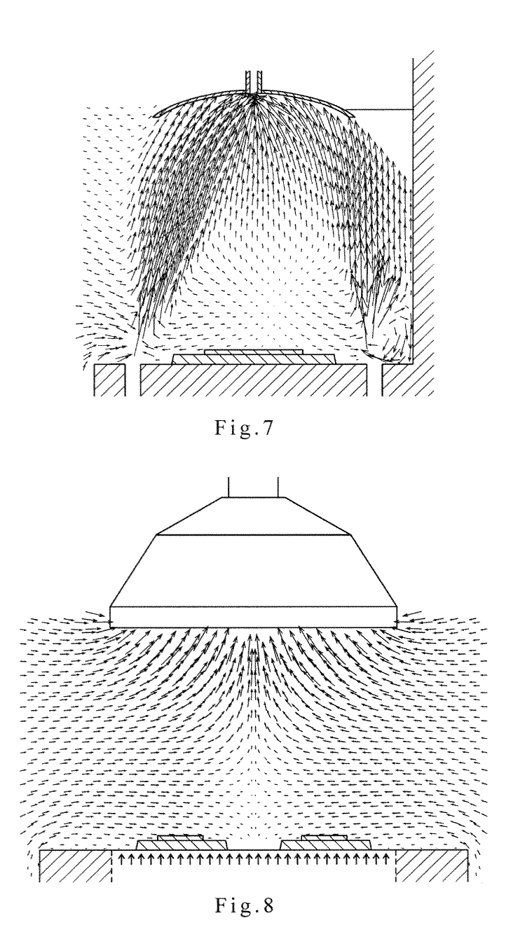

If a smoke is released on the counter top 77 and uses laser-assisted smoke flow visualization technique to trace the flow of the smoke on the planes across the side view, the flow patterns look just similar to that shown in FIG. 2. In addition, when measuring the velocity of the area under the suction device 70 by using laser Doppler velocimeter (LDV), the results are shown in FIGS. 5 and 6 when no rear wall and the cabinet above the suction device are installed. The status of the air flows in the area is almost identical to the disclosures in FIGS. 2 and 3. The results shown in FIGS. 7 and 8 are for the case when there are rear wall and the cabinet installed above the suction device 70. In the mediate portion of the area as shown in FIG. 7, there will be no recirculation bubbles close to the oven as shown in FIG. 5, rather has a source point. The velocity between the position below the source point and the position above the counter top 78 is small so that it would almost hardly affect the flames. The air curtain at the rear end is affected by the wall and performs an asymmetric pattern when compared with that of the front air curtain. The flows close to the rear wall generates corner vortexes due to the flow topology. Observations in the laboratory show that the smokes or pollutants restricted between the two air curtains can be effectively drawn away by the suction device 70 through the elongate suction opening 81.

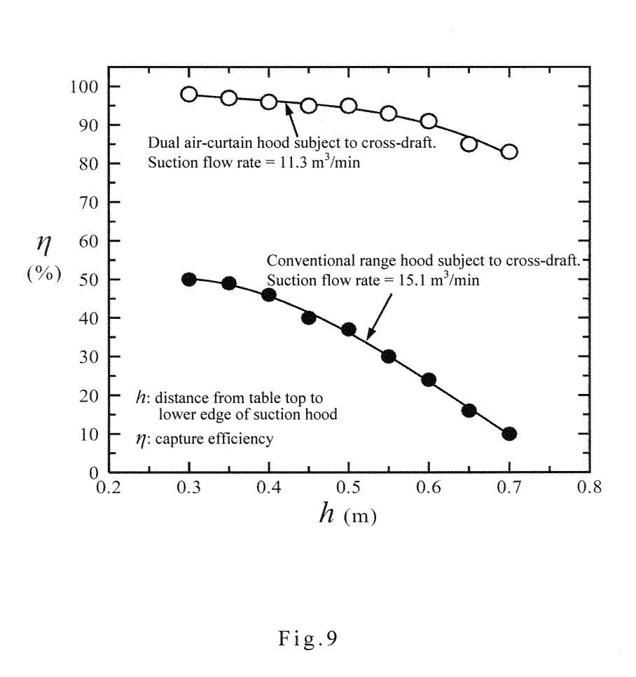

Moreover, the tracer gas method is used to examine the capture efficiencies of the present invention and the conventional range hood. The suction device is installed at different distances from the counter top and a large upright board swings at 0.35 m/s to simulate air flows generated by fan, or air conditioner or by people walking by the counter. Pure SF₆ gas is provided at constant flow rate by a gas releasing device placed on the counter top. The velocity and concentration of the SF₆ are detected at a remote cross section of the suction pipe. The capture efficiency, which is defined as the flow rate of SF₆ passes through the suction pipe divided by the flow rate of pure SF₆ released from the gas releasing device, can be calculated. The result is disclosed in FIG. 9. Obviously, the dual-air curtain range hood has much higher capture efficiency than that of the conventional range hood. The ability for reducing the interference by the reference flows of the range hood of the present invention is much higher than that of the conventional range hood.

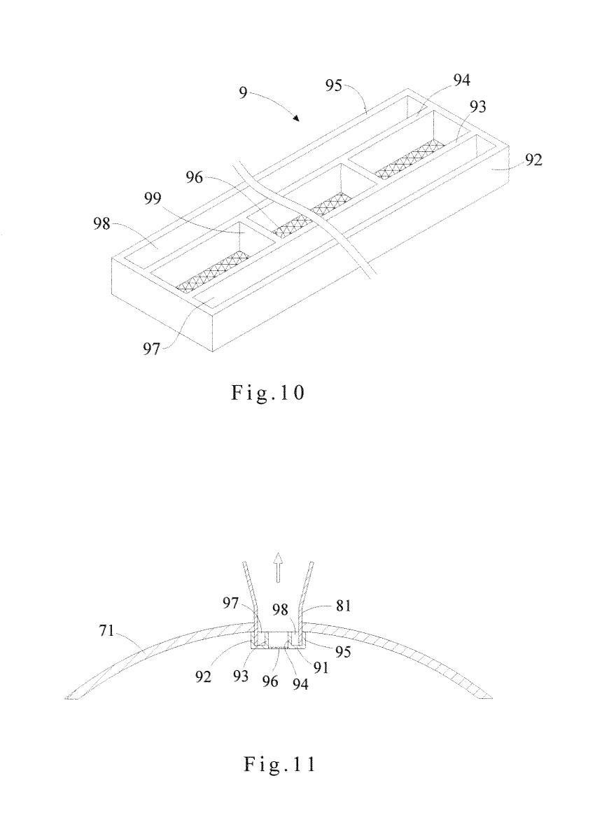

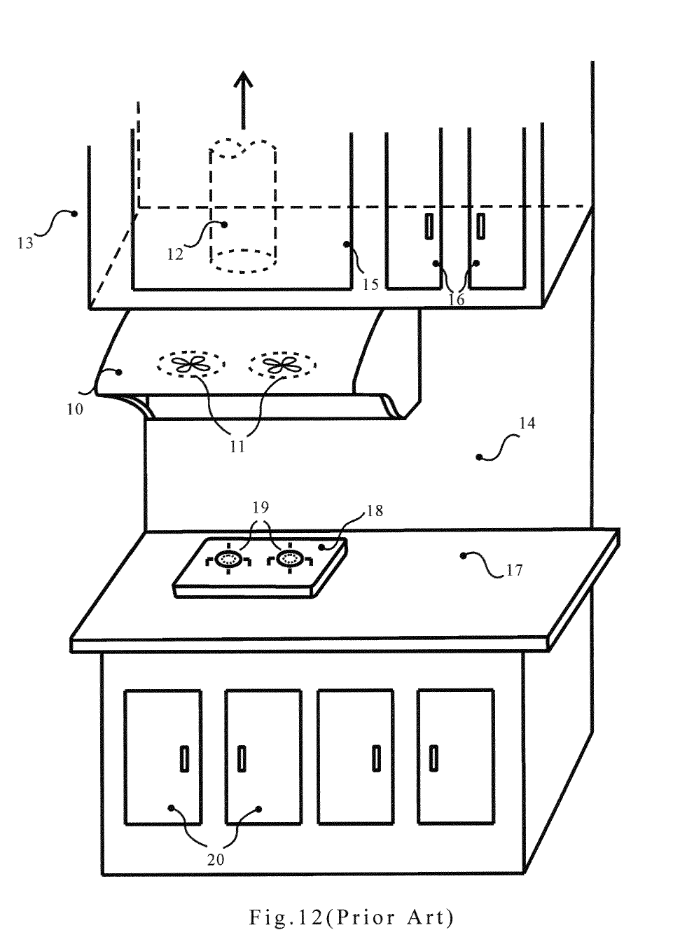

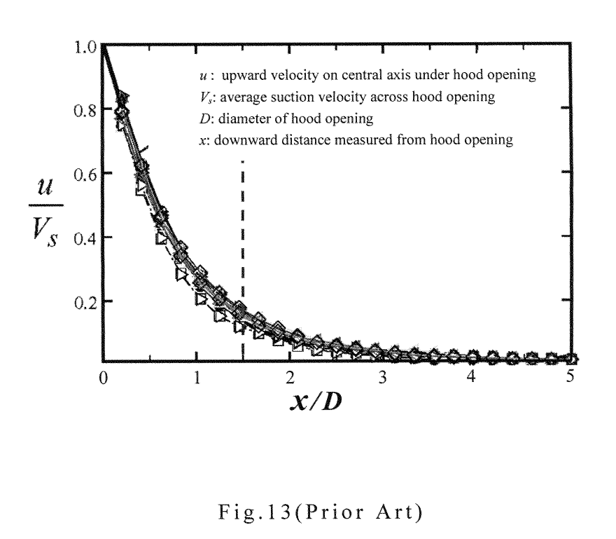

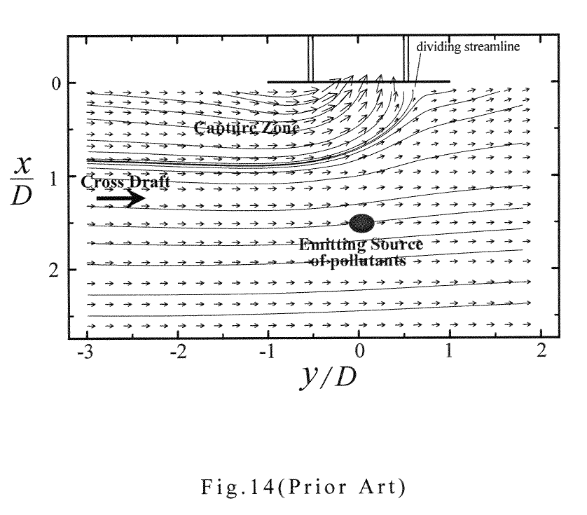

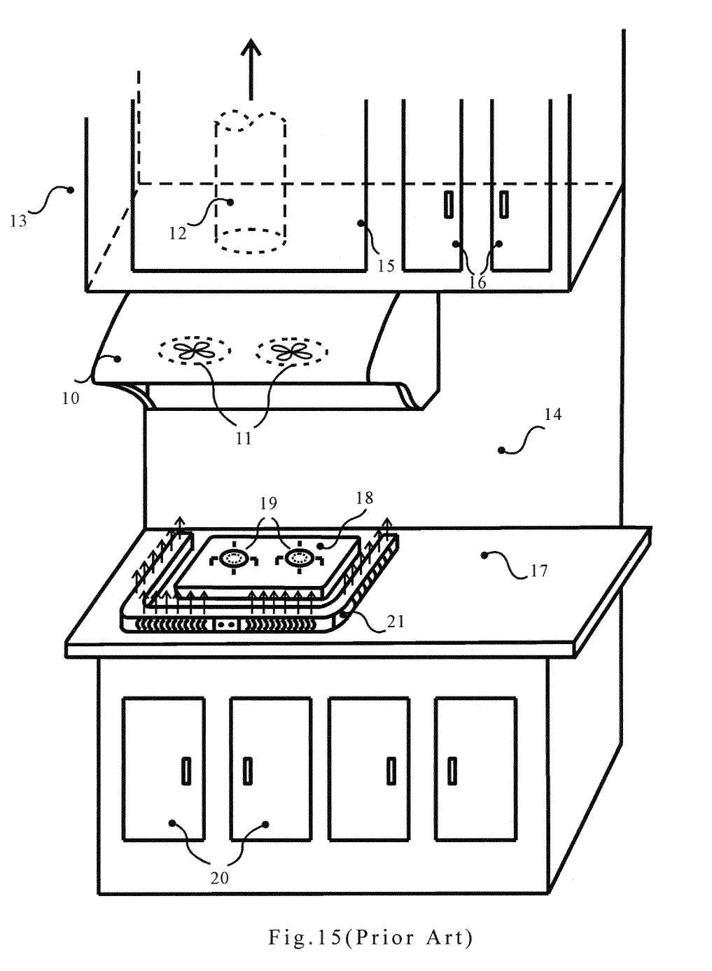

FIGS. 10 and 11 show an oil collection device 9 which is removably connected to the elongate suction opening 81 of the suction device 70 so as to collect the oil flowing along insides of the elongate suction opening 81. The elongate suction opening 81 protrudes a little from the flanges 71 and faces downward. The oil collection device 9 is a rectangular box with an open top and includes a base board 91 from which a first side panel 92, a first upright board 93, a second upright board 94 and a second side panel 95 extend upward. A filter 96 is connected to the base board 91. A first space 97 is defined between the first side panel 92, the first upright board 93 and the base board 91, and a second space 98 is defined between the second side panel 95, the second upright board 94 and the base board 91. Two support plates 99 are located above the filter 96 and connected between the first and second upright boards 93, 94.

When pushing the oil collection device 9 upward to engage with the elongate suction opening 81, the first and second side panels 92, 95 are engaged with two outsides of the elongate suction opening 81. When the gas containing pollutants are sucked and passed through the filter 96, the oil mist may be condensed into grease particles and attach on the insides of the elongate suction opening 81. The condensed grease will flow along the insides of the suction device 70 by the effect of gravity and drop into the first and second spaces 97, 98. The grease collected in the first and second spaces 97, 98 can be cleaned by removing the oil collection device 9 from the elongate suction opening 81.

While we have shown and described the embodiment in accordance with the present invention, it should be clear to those skilled in the art that further embodiments may be made without departing from the scope of the present invention.

What is claimed is:

1. A pollutant removing device comprising:
a first air blow device and a second air blow device respectively located at a front end and a rear end of a pollutant generation source and respectively including a first elongate air blow slot and a second elongate air blow slot so as to blow air upward, and
a suction device located above a counter top to which the pollutant generation source is installed, the suction device including at least one elongate suction opening which is connected with a suction machine, the at least one elongate suction opening being parallel to the first and second elongate air blow slots, two air curtains being formed between the at least one elongate suction opening, the first and second elongate air blow slots.

2. The device as claimed in claim 1, wherein the at least one elongate suction opening is located between the first and second elongate air blow slots.

3. A range hood using pollutant removing device comprising:
a first air blow device and a second air blow device respectively located at a front end and a rear end of a oven and respectively including a first elongate air blow slot and a second elongate air blow slot, the first and second elongate air blow slots located in a counter top so as to blow air upward, and
a suction device located above the counter top to which the burner is installed, the suction device including at least one elongate suction opening which is connected with a suction machine, the at least one elongate suction opening being parallel to the first and second elongate air blow slots, two air curtains being formed between the at least one elongate suction opening, the first and second elongate air blow slots.

4. The device as claimed in claim 3, wherein the at least one elongate suction opening is located between the first and second elongate air blow slots.

5. The device as claimed in claim 3, wherein the first air blow device and the second air blow device are two cross flow fans which are co-operated with the suction machine.

6. The device as claimed in claim 3 further comprising a blower communicates with the first and second elongate air blow slots and co-operated with the suction machine.

7. The device as claimed in claim 3 further comprising an oil collection device which is removably connected to the at least one elongate suction opening of the suction device.

8. The device as claimed in claim 7, wherein the oil collection device is a rectangular box with an open top and includes a base board from which a first side panel, a first upright board, a second upright board and a second side panel extend upward, a filter is connected to the base board, a first space is defined between the first side panel, the first upright board and the base board, a second space is defined between the second side panel, the second upright board and the base board, the first and second side panels are engaged with two outsides of the at least one elongate suction opening and adapted to collect oil flowing along insides of the at least one elongate suction opening in the first and second spaces.
